(19) United States
(12) Patent Application Publication
(10) Pub. No.: US 2026/0158527 A1
(43) Pub. Date: Jun. 11, 2026

(54) VACUUM HEAD FOR EFFICIENT LIQUID AND DEBRIS REMOVAL FROM INSIDE PIPES AND METHOD FOR USING THE SAME

(71) Applicant: Ken Beyer, Hamilton, MI (US)

(72) Inventor: Ken Beyer, Hamilton, MI (US)

(21) Appl. No.: 19/414,870

(22) Filed: Dec. 10, 2025

Related U.S. Application Data
(60) Provisional application No. 63/730,633, filed on Dec. 11, 2024.

(51) Int. Cl. B08B 9/043

(52) U.S. Cl. CPC B08B 9/0436; B08B 2209/04

(57) ABSTRACT

A vacuum head apparatus for cleaning pipe interiors includes a tubular body defining a longitudinal axis and having a proximal end, a distal end, and a central passage extending therebetween for debris flow. A plurality of circumferential fins extend radially outward from the tubular body exterior surface in spaced relation along the longitudinal axis. An intake opening at the distal end defines an intake plane oriented at a non-perpendicular angle relative to the longitudinal axis. The circumferential fins are configured to sealingly engage an interior surface of a pipe during cleaning operations. In certain embodiments, the tubular body is flexible and radially compressible to accommodate varying pipe diameters. In operation, the vacuum head is inserted into a pipe, vacuum pressure is applied, and the apparatus is advanced through the pipe while maintaining sealing engagement and extracting debris through the intake opening.

### COPYRIGHT NOTICE

This application includes material that is subject to copyright protection. The copyright owner has no objection to the facsimile reproduction by anyone of the patent disclosure, as it appears in the United States Patent and Trademark Office files or records, but otherwise reserves all copyright rights whatsoever.

### CROSS-REFERENCE TO RELATED APPLICATIONS

This application claims the benefit of U.S. Provisional Application Ser. No. 63/730,633, entitled “Vacuum Head for Efficient Liquid and Debris Removal from Inside Pipes,” filed Dec. 11, 2024—all of which is hereby incorporated herein by reference in its entirety, including all references cited therein.

### STATEMENT REGARDING FEDERALLY SPONSORED RESEARCH OR DEVELOPMENT

Not applicable.

REFERENCE TO A SEQUENCE LISTING

Not applicable.

### BACKGROUND OF THE INVENTION

### 1. Field of the Invention

The present invention relates generally to pipe cleaning devices, systems, and methods, and more particularly to vacuum-based extraction apparatus for removing accumulated debris, liquids, sediment, and other deleterious materials from the interior surfaces of pipes, conduits, and tubular conveyances. Still more specifically, the invention pertains to vacuum head structures incorporating circumferential fin arrangements and angled intake geometries configured to establish effective sealing engagement with pipe walls and optimize suction efficiency during cleaning operations. The invention further relates to methods for deploying such vacuum head apparatus within pipe systems, including techniques for navigating bends, accommodating diameter variations, and preparing pipe interiors for subsequent rehabilitation treatments such as relining, coating, or structural repair.

### 2. Background of the Invention

The maintenance, cleaning, and rehabilitation of pipe systems presents significant technical and operational challenges across a broad spectrum of industries and applications. Residential plumbing systems accumulate organic matter, mineral deposits, and sedimentary buildup that progressively restrict flow capacity and degrade water quality. Commercial and industrial processing facilities contend with manufacturing byproducts, chemical residues, and process-specific contaminants that adhere to pipe interior surfaces and resist conventional removal techniques. Municipal infrastructure, including sanitary sewer lines, storm water conveyances, and potable water distribution networks, suffer from infiltration of soil, gravel, sand, root intrusion, and the gradual accumulation of calcite deposits that compromise system integrity and hydraulic performance. In each of these contexts, the effective removal of accumulated materials from pipe interiors represents a critical prerequisite to maintaining system functionality, extending service life, and preparing surfaces for rehabilitation treatments.

Conventional approaches to pipe cleaning have historically relied upon hydro jetting technology, wherein high-pressure water streams are directed against pipe interior surfaces to dislodge and flush away accumulated debris. While hydro jetting remains a viable technique for certain applications, this methodology has proven problematic in numerous scenarios. High-pressure water alone frequently proves insufficient to mobilize and transport dense materials such as gravel, sand, aggregate, and accumulated sediment from the pipe interior. The water-based approach inherently introduces additional moisture into the pipe environment, which can prove counterproductive when the objective is to prepare pipe surfaces for moisture-sensitive rehabilitation treatments such as cured-in-place pipe liners, spray-applied coatings, or structural repair compounds. Moreover, hydro jetting equipment requires substantial water supply infrastructure, generates significant wastewater requiring capture and disposal, and may damage deteriorated pipe structures through the application of excessive hydraulic forces.

Vacuum-based extraction systems offer theoretical advantages over hydro jetting by directly removing debris rather than merely displacing it, by operating without the introduction of additional moisture, and by applying extraction forces that are less likely to damage compromised pipe structures. However, current vacuum-based cleaning systems employ vacuum heads that frequently fail to establish and maintain an adequate seal with the pipe's interior surface during cleaning operations. This fundamental deficiency creates excessive air gaps between the vacuum head periphery and the pipe wall, thereby establishing parasitic air pathways that substantially reduce the suction force available for effective debris extraction. The magnitude of suction loss attributable to inadequate sealing increases proportionally with the size and number of air gaps, such that even modest sealing deficiencies can result in dramatic reductions in effective extraction capability. The compromised suction power attendant to poor sealing leads to incomplete cleaning, necessitating multiple passes through the same pipe section, employment of alternative or supplementary cleaning methods, or acceptance of substandard cleaning results. These inefficiencies translate directly into increased operational costs, extended equipment deployment times, elevated labor expenditures, and potential damage to the pipe system from repeated mechanical interventions.

The consequences of inadequate pipe cleaning extend beyond immediate operational inefficiencies to severely impact subsequent rehabilitation efforts. Modern trenchless pipe rehabilitation technologies, including cured-in-place pipe lining, spray-applied polymer coatings, and structural repair systems, depend critically upon proper surface preparation for successful application and long-term performance. The presence of residual debris, even in small quantities, can prevent proper mechanical bonding between rehabilitation materials and the host pipe substrate. Retained moisture can interfere with the curing chemistry of thermoset resins and polymer coatings, resulting in incomplete polymerization, compromised mechanical properties, and premature failure of the rehabilitation treatment. Particulate contamination trapped beneath applied liners or coatings creates stress concentration points that propagate into delamination failures under service conditions. These surface preparation failures often remain latent until the rehabilitated pipe is returned to service, at which point they manifest as coating failures, liner collapses, or joint infiltration that necessitates costly remedial intervention. In many instances, the failed rehabilitation treatment must be completely removed and the entire process repeated, representing a substantial multiplication of project costs and service disruption.

The limitations of existing vacuum head designs are particularly pronounced when confronting the geometric complexities inherent in real-world pipe systems. Pipe networks rarely present uniform interior diameters throughout their length, instead exhibiting diameter variations attributable to manufacturing tolerances, joint configurations, service connections, localized corrosion, and accumulated deposits. Pipe interior surfaces frequently present irregular profiles including joint offsets, protruding gaskets, localized pitting, and areas of differential deposit accumulation. Pipe alignments incorporate bends, curves, and directional changes that a cleaning device must successfully navigate while maintaining effective operation. Prior art vacuum heads typically lack sealing structures capable of maintaining consistent contact with pipe interior surfaces throughout a cleaning operation. The absence of effective circumferential sealing elements results in substantial air bypass around the vacuum head periphery, dramatically reducing suction efficiency. Furthermore, conventional vacuum head intake configurations fail to optimize debris capture and dislodgement, particularly when encountering adhered deposits or heavier debris types including iron scale, calcite, concrete fragments, and dense mineral sediments.

Accordingly, there exists a substantial and long-felt need in the pipe cleaning and rehabilitation industry for an improved vacuum head design that overcomes the limitations of existing devices and provides more efficient, effective, and reliable pipe cleaning capabilities. Such an improved design should incorporate sealing structures that establish and maintain effective engagement with pipe interior surfaces across a range of pipe diameters and surface conditions. The improved design should feature an intake geometry optimized for debris dislodgement and capture. In certain applications, the improved design may benefit from flexible construction that accommodates geometric variations including diameter changes, surface irregularities, and directional bends. The improved design should provide sufficient suction retention to effectively extract challenging debris types including dense sediments, mineral deposits, and particulate materials. The improved design should prepare pipe surfaces adequately for subsequent rehabilitation treatments without introducing moisture or causing mechanical damage. These and other objects of the present invention will become apparent in light of the present specification, claims, and drawings.

### SUMMARY OF THE INVENTION

The following presents a simplified summary in order to provide a basic understanding of some aspects of the claimed subject matter. This summary is not an extensive overview and is not intended to identify key or critical elements or to delineate the scope of the claimed subject matter. Its purpose is to present certain concepts in a simplified form as a prelude to the more detailed description that is presented later.

The present invention addresses the aforementioned deficiencies in existing pipe cleaning technology by providing a novel vacuum head apparatus incorporating circumferential fin arrangements and angled intake geometry specifically engineered to establish and maintain effective sealing engagement with pipe interior surfaces, thereby maximizing suction efficiency and enabling superior debris and liquid extraction from pipe interiors.

In one aspect, the invention provides a vacuum head apparatus for cleaning pipe interiors comprising a tubular body defining a longitudinal axis and having a proximal end, a distal end, and a central passage extending therebetween for debris flow. A plurality of circumferential fins extend radially outward from an exterior surface of the tubular body, with the fins being arranged in spaced relation along the longitudinal axis. An intake opening is formed at the distal end of the tubular body, with the intake opening defining an intake plane oriented at a non-perpendicular angle relative to the longitudinal axis, thereby facilitating debris dislodgement and capture during cleaning operations.

In certain embodiments, the plurality of circumferential fins are configured to sealingly engage an interior surface of a pipe when the vacuum head apparatus is disposed within the pipe. The sealing engagement between the fins and the pipe interior surface minimizes parasitic air gaps and maximizes suction forces available for debris capture and transport.

In certain embodiments, the distal end of the tubular body comprises a domed exterior profile. The domed profile facilitates smooth insertion into pipes and navigation through pipe bends and diameter transitions.

In certain embodiments, the vacuum head apparatus further comprises a coupling structure disposed at the proximal end and configured for connection to a vacuum conduit. The coupling structure may comprise a threaded exterior surface sized to engage standard vacuum hoses, such as one and one-half inch vacuum hoses commonly employed in pipe cleaning applications.

In certain preferred embodiments, the tubular body is flexible and radially compressible from a relaxed state to a compressed state, enabling the apparatus to accommodate varying pipe interior diameters. In such embodiments, each of the circumferential fins may be independently compressible in a radial direction, enabling individual fins to conform to localized variations in pipe interior surface geometry. The flexible tubular body may comprise an elastomeric material having a first durometer hardness value, and the plurality of circumferential fins may comprise an elastomeric material having a second durometer hardness value less than the first durometer hardness value. This differential durometer construction provides a body of sufficient structural rigidity to maintain central passage integrity while providing fins of sufficient compliance to conform intimately to pipe interior surfaces and establish effective sealing engagement. In particularly preferred embodiments, the first durometer hardness value is between approximately 60 and 80 Shore A, and the second durometer hardness value is between approximately 30 and 50 Shore A. In further preferred embodiments, fins positioned nearer the proximal end exhibit greater stiffness than fins positioned nearer the distal end, creating a progressive stiffness gradient that establishes a sealing zone of increasing compression toward the vacuum source while permitting more compliant forward fins to conform and scrape during advancement through the pipe.

In certain embodiments, the vacuum head apparatus further comprises at least one internal reinforcement structure disposed within the central passage and configured to resist radial collapse of the tubular body under applied vacuum pressure. In preferred embodiments, the plurality of circumferential fins comprises at least four fins, and adjacent fins are separated by a substantially uniform spacing distance.

In another aspect, the invention provides a system for cleaning pipe interiors comprising the vacuum head apparatus described herein, a flexible vacuum conduit having a first end connected to the proximal end of the vacuum head apparatus and a second end, and a vacuum source connected to the second end of the flexible vacuum conduit. In preferred embodiments, the system further comprises a debris collection vessel disposed in fluid communication between the flexible vacuum conduit and the vacuum source for accumulating extracted debris. In certain embodiments, the system further comprises a tether having a first tether end connected to the vacuum head apparatus at or adjacent the distal end and a second tether end extending externally of the pipe for manipulation by an operator.

In yet another aspect, the invention provides a method of cleaning a pipe interior comprising the steps of providing the vacuum head apparatus described herein, inserting the vacuum head apparatus into a pipe wherein the plurality of circumferential fins engage an interior surface of the pipe, applying vacuum pressure to the proximal end of the vacuum head apparatus, and advancing the vacuum head apparatus through the pipe while maintaining engagement between the plurality of circumferential fins and the interior surface and extracting debris through the intake opening. In preferred embodiments, the method further comprises withdrawing the vacuum head apparatus through the pipe in a direction opposite the advancing. In certain embodiments, the method further comprises navigating the vacuum head apparatus through a bend in the pipe.

### BRIEF DESCRIPTION OF THE DRAWINGS

Certain embodiments of the present invention are illustrated by the accompanying figures. It will be understood that the figures are not necessarily to scale and that details not necessary for an understanding of the invention or that render other details difficult to perceive may be omitted. It will be further understood that the invention is not necessarily limited to the particular embodiments illustrated herein. The invention will now be described with reference to the drawings wherein:

FIG. 1 is a perspective view of a vacuum head apparatus according to the present invention, showing the tubular body, plurality of circumferential fins, and angled intake opening at the distal end.

FIG. 2 is a front elevation view of the vacuum head apparatus showing the proximal end with the threaded coupling structure and central passage opening.

FIG. 3 is a longitudinal cross-sectional view of the vacuum head apparatus taken along line A-A, showing the central passage extending from the proximal end to the distal end, the wall thickness of the tubular body, and the profile of the circumferential fins.

FIG. 4 is a side elevation view of the vacuum head apparatus showing the arrangement of the plurality of circumferential fins along the longitudinal axis.

FIG. 5 is a rear elevation view of the vacuum head apparatus showing the exterior surface of the tubular body and an embossed text region.

FIG. 6 is a bottom view of the vacuum head apparatus of FIG. 1.

FIG. 7 is a schematic diagram of a system for cleaning pipe interiors according to the present invention, showing the vacuum head apparatus deployed within a pipe in operative connection with a flexible vacuum conduit, debris collection vessel, vacuum source, and tether.

FIG. 8 is a flow diagram illustrating a method of cleaning a pipe interior according to the present invention.

### REFERENCE NUMERALS

Reference numerals used throughout the detailed description and drawings correspond to the following elements:
10—vacuum head apparatus
12—tubular body (optionally flexible)
14—longitudinal axis
16—proximal end
18—distal end
20—central passage
22—circumferential fins
24—exterior surface
26—intake opening
28—intake plane
30—coupling structure
32—threaded exterior surface
34—internal reinforcement structure
100—system
102—flexible vacuum conduit
104—first end of conduit
106—second end of conduit
108—vacuum source
110—debris collection vessel
112—tether
114—first tether end
116—second tether end
118—target pipe
120—pipe interior surface
200—provide apparatus
202—insert into pipe
204—apply vacuum
206—advance through pipe
208—navigate bend
210—withdraw
212—complete extraction

### DETAILED DESCRIPTION OF THE INVENTION

While this invention is susceptible of embodiment in many different forms and applications, there are shown in the drawings and described herein in detail several specific embodiments with the understanding that the present disclosure is to be considered as an exemplification of the principles of the invention and is not intended to limit the invention to the embodiments illustrated. It will be understood that like or analogous elements and components, referred to herein, may be identified throughout the drawings by like reference characters. In addition, it will be understood that the drawings are merely schematic representations of certain embodiments of the invention, and some of the components may have been distorted from their actual scale for purposes of pictorial clarity.

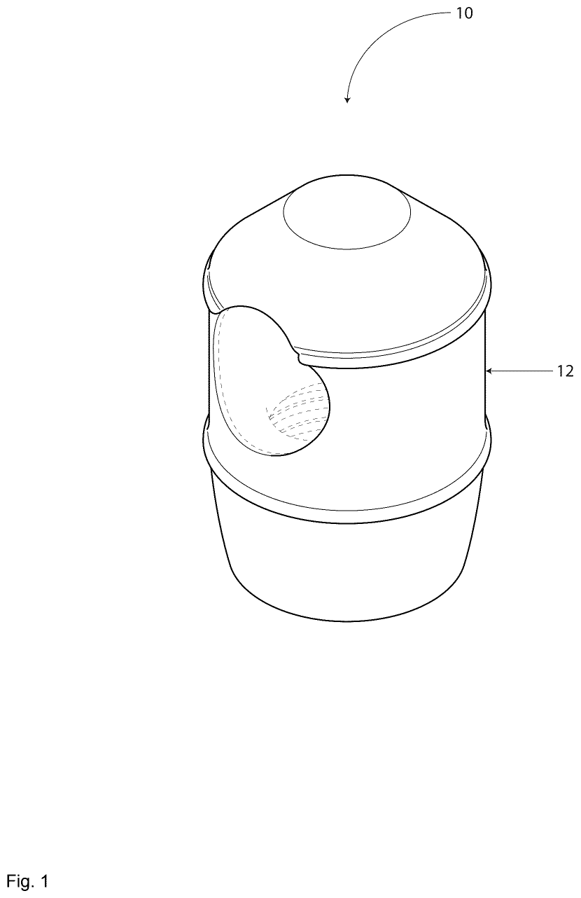

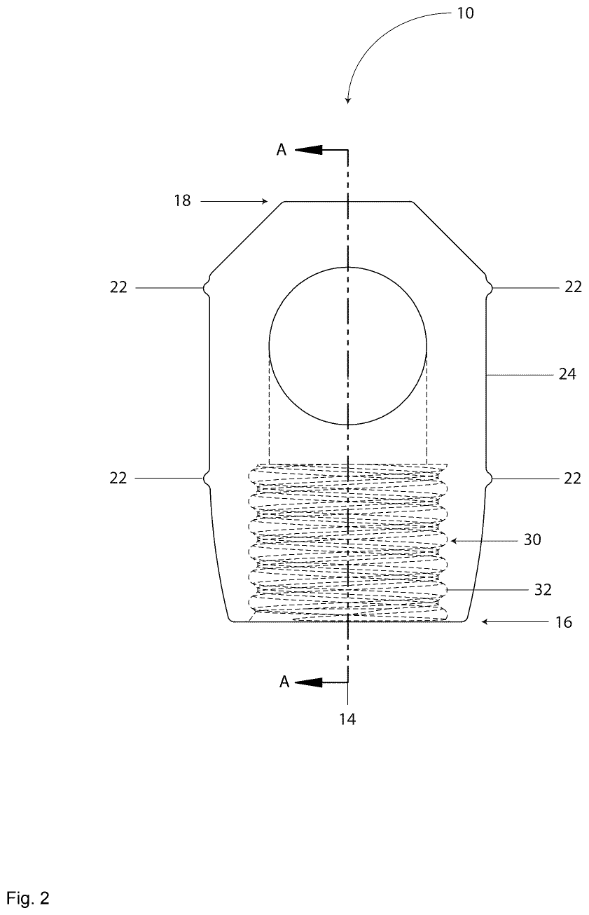

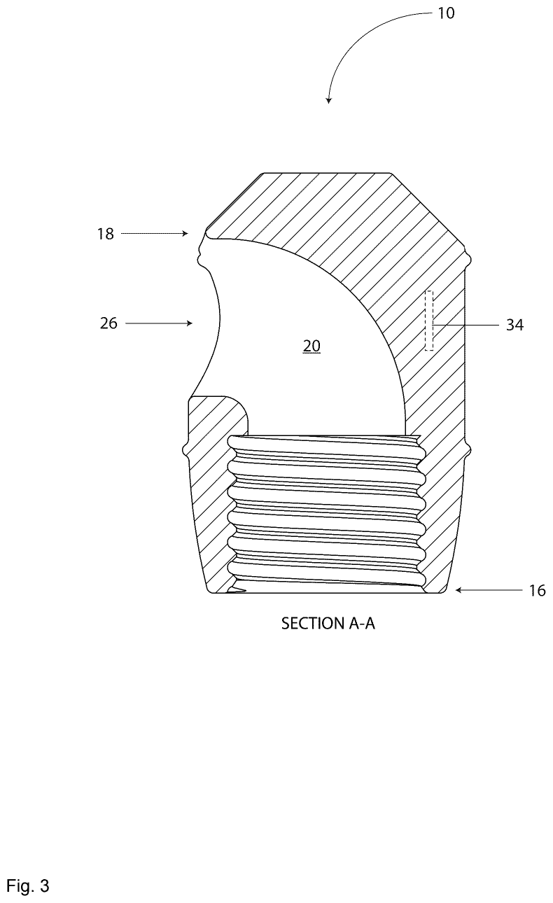

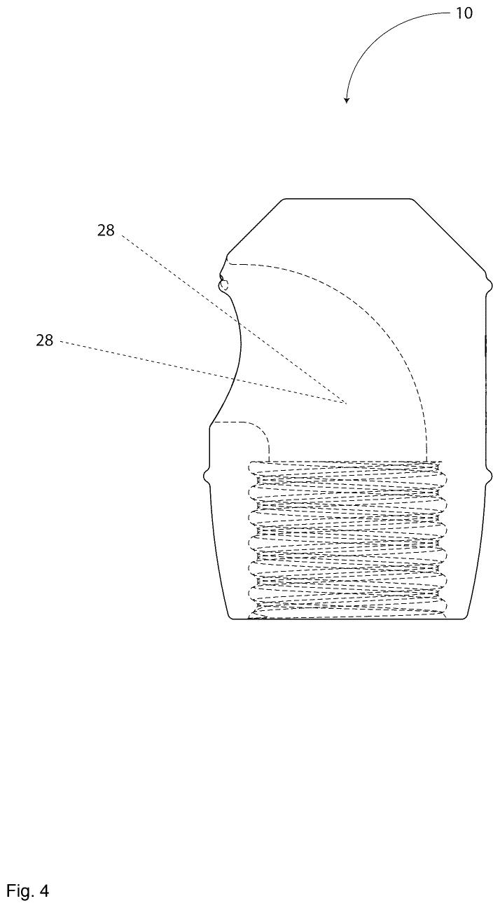

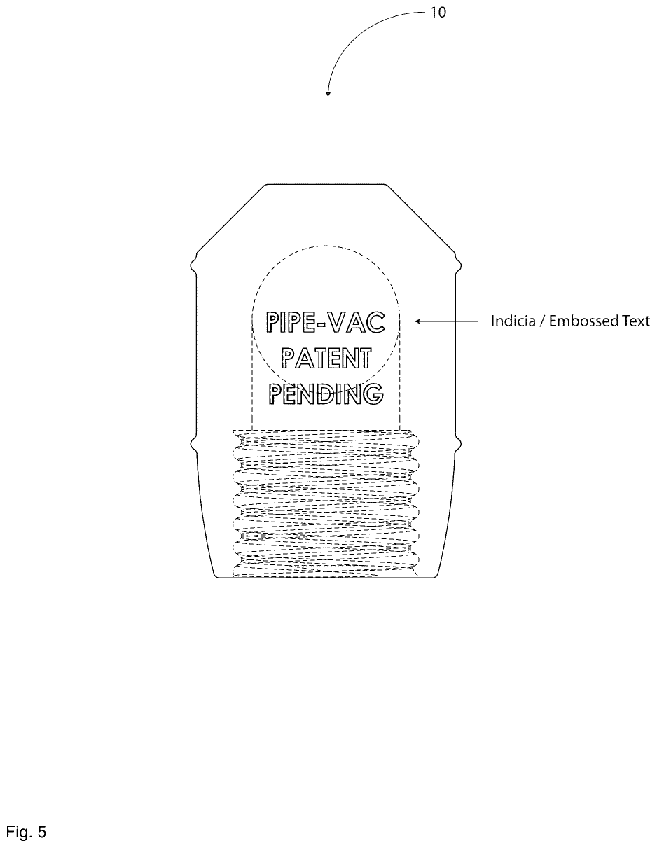

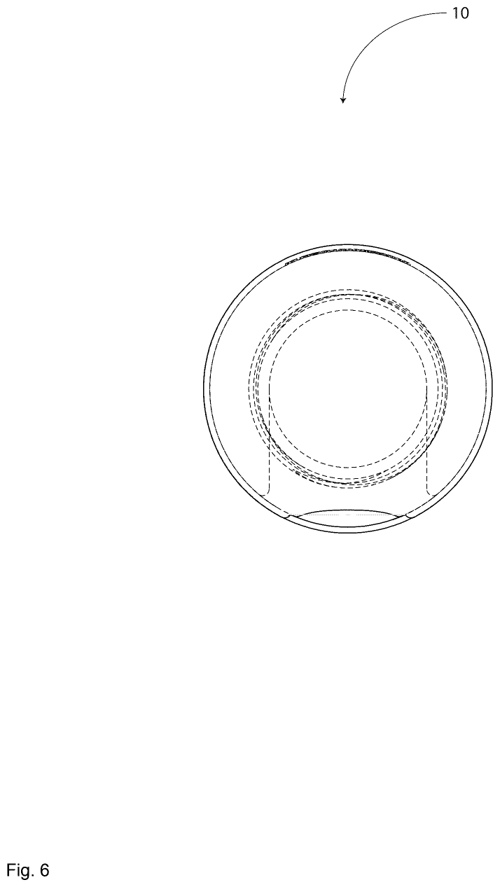

Referring now to FIGS. 1-6 collectively, there is shown a vacuum head apparatus 10 according to the present invention. Vacuum head apparatus 10 is specifically engineered for the extraction of liquids, debris, sediment, and other accumulated materials from the interior of pipes, conduits, and tubular conveyances. Vacuum head apparatus 10 achieves superior extraction efficiency through the combination of circumferential fin structures configured to establish and maintain effective sealing engagement with pipe interior surfaces and an angled intake geometry optimized for debris dislodgement and capture. This configuration minimizes parasitic air gaps and maximizes the suction forces available for debris capture and transport.

Vacuum head apparatus 10 includes a tubular body 12 defining a longitudinal axis 14. Tubular body 12 has a proximal end 16 and a distal end 18 disposed at opposite ends along longitudinal axis 14. Proximal end 16 is configured for connection to a vacuum source, while distal end 18 is configured for debris ingress during cleaning operations. In certain embodiments, distal end 18 of tubular body 12 comprises a domed exterior profile. The domed exterior profile presents a smooth, curved surface that facilitates insertion of vacuum head apparatus 10 into pipe openings and promotes smooth navigation through pipe bends, diameter transitions, and past surface irregularities. The domed configuration reduces the likelihood of the vacuum head apparatus 10 catching on joint offsets, protruding gaskets, or other internal pipe features that might impede advancement.

Referring particularly to FIGS. 1-6, tubular body 12 defines a central passage 20 extending from proximal end 16 to distal end 18. Central passage 20 provides a fluid communication pathway through which debris, liquids, and other extracted materials flow under the influence of applied vacuum pressure. Central passage 20 is configured with an interior diameter sufficient to accommodate the transport of debris particles, sediment accumulations, and liquid volumes anticipated in pipe cleaning applications. In a preferred embodiment, central passage 20 has an interior diameter of approximately one and one-half inches, corresponding to standard vacuum hose dimensions employed in pipe cleaning equipment. The wall thickness of tubular body 12 between central passage 20 and exterior surface 24 of tubular body 12 is selected to provide adequate structural integrity to resist collapse under applied vacuum pressure.

Vacuum head apparatus 10 further includes a plurality of circumferential fins 22 extending radially outward from an exterior surface 24 of tubular body 12. Fins 22 are arranged in spaced relation along longitudinal axis 14 between proximal end 16 and distal end 18. Each of fins 22 extends circumferentially around exterior surface 24 and projects radially outward therefrom. Fins 22 are configured to sealingly engage an interior surface of a pipe when vacuum head apparatus 10 is disposed within the pipe. The sealing engagement established by fins 22 minimizes air bypass around the periphery of vacuum head apparatus 10, thereby concentrating suction forces at intake opening 26 for effective debris extraction. In preferred embodiments, plurality of circumferential fins 22 comprises at least four fins 22, and adjacent fins 22 are separated by a substantially uniform spacing distance. The number and spacing of fins 22 are selected to optimize the balance between sealing effectiveness, debris capture capability, navigation through pipe bends, and ease of advancement through the pipe. Fins 22 may be integrally formed with tubular body 12 as a unitary structure, or fins 22 may be separately formed and subsequently attached to tubular body 12 through bonding, welding, overmolding, or mechanical attachment methods.

Referring again to FIGS. 1-6, vacuum head apparatus 10 further includes an intake opening 26 formed at distal end 18 of tubular body 12. Intake opening 26 provides fluid communication between the pipe interior environment and central passage 20 for ingress of debris during vacuum extraction operations. Intake opening 26 defines an intake plane 28 oriented at a non-perpendicular angle relative to longitudinal axis 14. The angled orientation of intake plane 28 provides a scooping and scraping action as vacuum head apparatus 10 is advanced through a pipe, facilitating dislodgement of adhered debris and capture of loose materials. In preferred embodiments, intake plane 28 is oriented at an angle of between approximately 30 degrees and approximately 60 degrees relative to longitudinal axis 14, with an angle of approximately 45 degrees being particularly preferred for optimal debris dislodgement and capture. The elongated profile of intake opening 26 resulting from the angled orientation of intake plane 28 presents an increased capture area compared to a perpendicular opening of equivalent diameter, enhancing debris extraction efficiency. The leading edge of intake opening 26, formed by the intersection of intake plane 28 with the exterior of tubular body 12, provides a scraping surface that engages adhered deposits as vacuum head apparatus 10 advances through the pipe.

Referring particularly to FIGS. 1-6, vacuum head apparatus 10 further includes a coupling structure 30 disposed at proximal end 16. Coupling structure 30 is configured for connection to a vacuum conduit, thereby enabling vacuum head apparatus 10 to be placed in operative communication with a vacuum source. In preferred embodiments, coupling structure 30 comprises a threaded exterior surface 32 sized to engage standard vacuum hoses employed in pipe cleaning applications. In a particularly preferred embodiment, threaded exterior surface 32 is sized to engage a standard one and one-half inch vacuum hose. The threaded connection between coupling structure 30 and the vacuum conduit establishes a secure and substantially airtight junction that maintains vacuum integrity during cleaning operations. Alternative embodiments of coupling structure 30 may employ barbed fittings, quick-disconnect couplings, bayonet-style connectors, compression fittings, or other connection mechanisms suitable for establishing secure and substantially airtight connection to a vacuum conduit.

As is best shown in FIGS. 1-6, and in certain embodiments, vacuum head apparatus 10 further includes at least one internal reinforcement structure 34 disposed within tubular body 12 and proximate to central passage 20. Internal reinforcement structure 34 is configured to resist radial collapse of tubular body 12 under applied vacuum pressure. When vacuum pressure is applied to proximal end 16, the pressure differential between central passage 20 and the exterior environment creates forces tending to collapse tubular body 12 radially inward. Internal reinforcement structure 34 resists these collapsing forces and maintains the patency of central passage 20 throughout vacuum extraction operations. Internal reinforcement structure 34 may comprise longitudinal ribs extending along the interior wall of central passage 20, a semi-rigid inner sleeve disposed within central passage 20, a helical reinforcement member, annular reinforcement rings, or other structural configurations effective to resist radial collapse while permitting substantially unobstructed debris flow through central passage 20.

Vacuum head apparatus 10 may be constructed in accordance with various embodiments suited to different application requirements and manufacturing considerations. In a first embodiment, tubular body 12 and plurality of circumferential fins 22 are constructed from a substantially rigid or semi-rigid material. Suitable materials for the first embodiment include rigid thermoplastics such as acrylonitrile butadiene styrene (ABS), polyvinyl chloride (PVC), chlorinated polyvinyl chloride (CPVC), high-density polyethylene (HDPE), polypropylene (PP), acetal copolymer (POM), nylon (polyamide), or polycarbonate. The first embodiment is well-suited for applications where the target pipe interior diameter is known and consistent, and where the rigid construction provides manufacturing advantages such as compatibility with injection molding, extrusion, or additive manufacturing processes including three-dimensional printing. In the first embodiment, vacuum head apparatus 10 is sized to provide a close fit within the target pipe, with fins 22 dimensioned to engage the pipe interior surface and establish sealing contact sufficient to minimize air bypass during vacuum extraction operations. The rigid construction of the first embodiment provides dimensional stability, resistance to deformation under operational stresses, and predictable sealing performance within the design diameter range.

In a second embodiment, tubular body 12 is flexible and radially compressible from a relaxed state to a compressed state, enabling vacuum head apparatus 10 to accommodate varying pipe interior diameters. The relaxed state corresponds to the natural unstressed configuration of tubular body 12, while the compressed state corresponds to a radially reduced configuration assumed by tubular body 12 in response to external forces such as those encountered upon insertion into a pipe having an interior diameter smaller than the exterior diameter of tubular body 12 in its relaxed state. In the second embodiment, each of plurality of circumferential fins 22 is independently compressible in a radial direction, enabling individual fins 22 to conform to localized variations in pipe interior surface geometry, including surface irregularities, joint offsets, localized deposits, and areas of differential corrosion. The independent compressibility of fins 22 ensures that sealing engagement is maintained across the full circumference of the pipe interior surface even when that surface presents a non-uniform profile. The second embodiment is particularly advantageous for applications involving pipes of varying or unknown diameter, pipes exhibiting internal diameter variations along their length, or pipes presenting irregular interior surface profiles.

In certain preferred configurations of the second embodiment, tubular body 12 comprises an elastomeric material having a first durometer hardness value, and plurality of circumferential fins 22 comprise an elastomeric material having a second durometer hardness value less than the first durometer hardness value. This differential durometer construction provides tubular body 12 with sufficient structural rigidity to maintain central passage 20 integrity and withstand operational stresses, while providing fins 22 with sufficient compliance to conform intimately to pipe interior surfaces and establish effective sealing engagement therewith. In particularly preferred configurations, the first durometer hardness value for tubular body 12 is between approximately 60 and 80 Shore A, and the second durometer hardness value for fins 22 is between approximately 30 and 50 Shore A. The differential durometer construction may be achieved through co-molding processes wherein two elastomeric materials of different hardness are molded together in a single operation, through overmolding processes wherein fins 22 are molded over a pre-formed tubular body 12, through separate fabrication and subsequent attachment of fins 22 to tubular body 12, or through other manufacturing techniques capable of producing a structure having regions of differing durometer hardness.

In further preferred configurations of the second embodiment, plurality of circumferential fins 22 comprises a first fin positioned adjacent proximal end 16 and a last fin positioned adjacent distal end 18, wherein fins 22 positioned nearer proximal end 16 exhibit greater stiffness than fins 22 positioned nearer distal end 18. This progressive stiffness gradient creates a sealing zone of increasing compression toward the vacuum source while permitting the more compliant forward fins 22 to conform readily to surface variations and provide scraping action during advancement. The progressive stiffness gradient may be achieved through varying the cross-sectional dimensions of fins 22 along longitudinal axis 14, through varying the material composition or durometer hardness of fins 22 along longitudinal axis 14, through varying the fin spacing along longitudinal axis 14, or through combinations of these techniques.

In certain configurations of the second embodiment, tubular body 12 in the relaxed state has an exterior diameter greater than an interior diameter of a target pipe, whereby insertion of vacuum head apparatus 10 into the target pipe causes radial compression of tubular body 12 and plurality of circumferential fins 22 into sealing engagement with the target pipe. This oversized relationship between vacuum head apparatus 10 and the target pipe ensures positive sealing engagement upon insertion and throughout cleaning operations without requiring active adjustment by the operator or auxiliary sealing mechanisms. When vacuum pressure is applied, the pressure differential between central passage 20 and the exterior environment tends to draw fins 22 against the pipe interior surface, further enhancing the sealing engagement achieved through mechanical compression.

In a particular configuration of the second embodiment especially suited for pipes having interior diameters in the range of approximately two inches to approximately six inches, vacuum head apparatus 10 comprises tubular body 12 constructed from an elastomeric material and having a length of approximately four inches measured along longitudinal axis 14 and an exterior diameter of approximately two and three-quarter inches in the relaxed state. Central passage 20 extends through tubular body 12 and has an interior diameter of approximately one and one-half inches. Threaded coupling structure 30 is disposed at proximal end 16 and has threads sized to engage a standard one and one-half inch vacuum hose. Plurality of circumferential fins 22 comprises at least four fins extending radially outward from exterior surface 24 in spaced relation along longitudinal axis 14, with each of fins 22 being independently compressible in a radial direction. Intake opening 26 is formed at distal end 18 and defines intake plane 28 oriented at an angle of approximately forty-five degrees relative to longitudinal axis 14.

Vacuum head apparatus 10, and particularly tubular body 12 and plurality of circumferential fins 22, may be constructed from a variety of materials selected for their combination of mechanical properties, durability, and chemical resistance appropriate to the intended application environment. For rigid and semi-rigid constructions according to the first embodiment, suitable materials include engineering thermoplastics as described above, as well as fiber-reinforced polymer composites, thermoset plastics, and metal alloys where extreme durability or chemical resistance is required. For flexible constructions according to the second embodiment, suitable elastomeric material families include thermoplastic elastomers (TPE) such as styrenic block copolymers including styrene-butadiene-styrene (SBS) and styrene-ethylene-butylene-styrene (SEBS) formulations; thermoplastic polyurethanes (TPU) offering excellent abrasion resistance and mechanical strength; thermoplastic vulcanizates (TPV) comprising dynamically vulcanized polypropylene and ethylene-propylene-diene monomer (EPDM) blends; thermoset elastomers including vulcanized EPDM rubber providing superior ozone and weathering resistance; nitrile rubber (NBR) providing excellent resistance to hydrocarbons, oils, and petroleum-based contaminants; silicone elastomers providing exceptional service temperature range from cryogenic to elevated temperatures; and fluoroelastomers such as fluorinated rubber (FKM) and perfluoroelastomers (FFKM) providing superior chemical resistance in aggressive chemical environments. The selection of material for a particular application is guided by the nature of the pipe environment, including the composition of accumulated debris, the presence of chemical contaminants, the anticipated service temperature range, and the required service life of vacuum head apparatus 10.

The physical properties of the materials employed in vacuum head apparatus 10 may be characterized quantitatively to ensure consistent performance across manufacturing lots and to guide material selection for particular applications. Shore A hardness, as measured according to ASTM D2240, characterizes the resistance of the material to indentation and correlates with the stiffness and conformability of tubular body 12 and fins 22. Tensile strength, as measured according to ASTM D412, characterizes the resistance of the material to failure under tensile loading and is preferably in the range of approximately 500 to 3000 pounds per square inch depending upon the selected material family. Elongation at break, as measured according to ASTM D412, characterizes the extensibility of the material and is preferably in the range of approximately 200 to 700 percent for elastomeric constructions. Compression set, as measured according to ASTM D395 after 24 hours at elevated temperature, characterizes the ability of the material to recover its original dimensions after compressive deformation and is preferably less than approximately 30 percent for elastomeric constructions to ensure that fins 22 maintain their sealing function after repeated compression cycles. Tear resistance, as measured according to ASTM D624, characterizes the resistance of the material to propagation of cuts or nicks and is preferably in the range of approximately 100 to 300 pounds-force per linear inch. Abrasion resistance, as measured according to ASTM D5963 and reported as volume loss, is preferably less than approximately 150 cubic millimeters for applications involving abrasive debris. The service temperature range for vacuum head apparatus 10 is defined by the material selection and is preferably at least from approximately minus 20 degrees Fahrenheit to approximately plus 180 degrees Fahrenheit for general purpose applications, with specialized materials providing extended temperature ranges where required. Chemical resistance may be characterized by measuring the percent volume swell of the material after immersion in representative chemical environments according to ASTM D471, with lower swell percentages indicating superior chemical resistance. For rigid thermoplastic constructions, relevant properties include flexural modulus as measured according to ASTM D790, impact resistance as measured according to ASTM D256, and heat deflection temperature as measured according to ASTM D648.

The selection of materials for vacuum head apparatus 10 may be guided by the specific application environment. In sanitary sewer applications, tubular body 12 and fins 22 may be constructed from EPDM, TPV formulations, or rigid PVC providing resistance to wastewater constituents and biological degradation. In industrial process piping applications, the material selection may be guided by the specific process chemistry, with nitrile rubber being appropriate for hydrocarbon environments, fluoroelastomers being appropriate for aggressive chemical environments, and CPVC or polypropylene being appropriate for corrosive chemical service in rigid constructions. In potable water distribution applications, the material must comply with applicable regulatory requirements for contact with drinking water, such as NSF/ANSI Standard 61, which may favor certain TPE, EPDM, or NSF-listed rigid thermoplastic formulations. In applications requiring elevated temperature service, silicone elastomers, fluoroelastomers, or high-temperature thermoplastics such as polyphenylene sulfide (PPS) may be selected for their thermal stability. In applications requiring resistance to abrasive debris, thermoplastic polyurethanes or abrasion-resistant grades of rigid thermoplastics may be favored for their exceptional abrasion resistance.

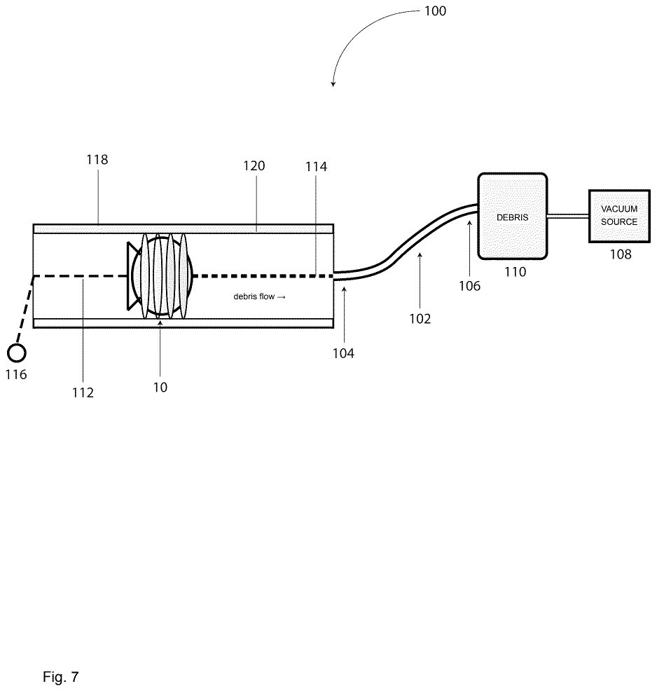

Referring now to FIG. 7, there is shown a system 100 for cleaning pipe interiors according to the present invention. System 100 includes vacuum head apparatus 10 as described herein, a flexible vacuum conduit 102 having a first end 104 connected to coupling structure 30 at proximal end 16 of vacuum head apparatus 10 and a second end 106, and a vacuum source 108 connected to second end 106 of flexible vacuum conduit 102. Flexible vacuum conduit 102 provides fluid communication between vacuum head apparatus 10 and vacuum source 108, enabling suction forces generated by vacuum source 108 to be transmitted to vacuum head apparatus 10 and enabling debris extracted through intake opening 26 to be transported toward vacuum source 108. In preferred embodiments, flexible vacuum conduit 102 has an interior diameter substantially equal to an interior diameter of central passage 20 of vacuum head apparatus 10, thereby minimizing flow restrictions and pressure losses at the junction between vacuum head apparatus 10 and flexible vacuum conduit 102.

System 100 preferably further includes a debris collection vessel 110 disposed in fluid communication between flexible vacuum conduit 102 and vacuum source 108. Debris collection vessel 110 accumulates extracted debris and prevents debris from reaching and potentially damaging vacuum source 108. Debris collection vessel 110 may comprise a rigid container, a flexible collection bag, a cyclonic separator, a filter assembly, or other collection device appropriate for the debris types anticipated in a particular application. In certain embodiments, system 100 further includes a tether 112 having a first tether end 114 connected to vacuum head apparatus 10 at or adjacent distal end 18 and a second tether end 116 extending externally of the pipe for manipulation by an operator. Tether 112 enables the operator to pull vacuum head apparatus 10 through the pipe during cleaning operations, providing controlled advancement and the ability to retrieve vacuum head apparatus 10 should it become lodged or encounter an obstruction. Tether 112 may comprise a rope, cable, chain, strap, or other elongate flexible member of sufficient strength to withstand the pulling forces required to advance vacuum head apparatus 10 through the pipe.

In operation, vacuum head apparatus 10 is deployed within a target pipe 118 having a pipe interior surface 120. Target pipe 118 may comprise metallic pipe such as cast iron, ductile iron, steel, or copper; cementitious pipe such as concrete or asbestos cement; polymeric pipe such as polyvinyl chloride, high-density polyethylene, or acrylonitrile butadiene styrene; clay pipe; or other pipe materials encountered in residential, commercial, industrial, or municipal applications. Pipe interior surface 120 may present accumulated debris, sediment, scale, biological growth, mineral deposits, or other materials requiring removal prior to continued service or rehabilitation treatment.

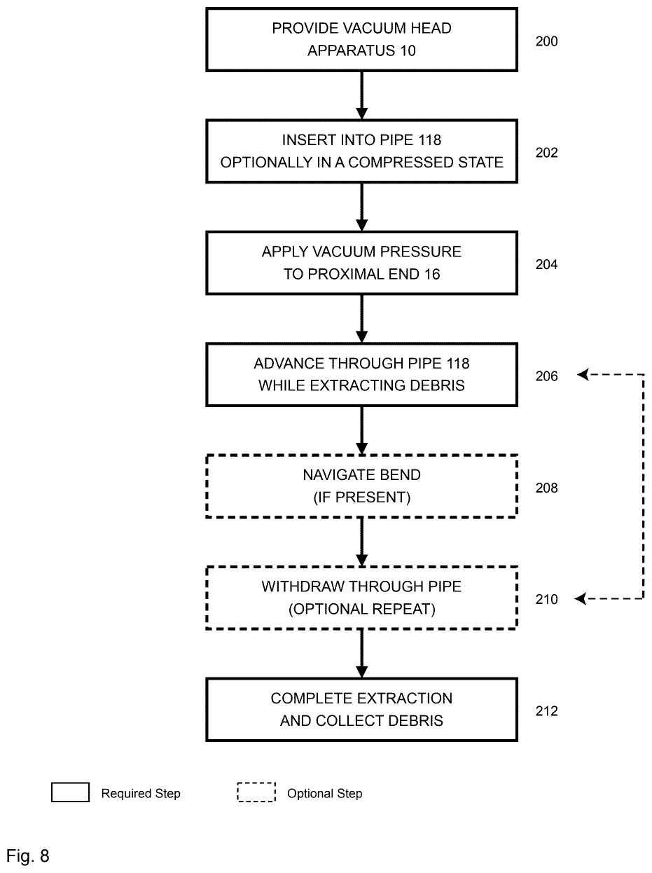

Referring now to FIG. 8, there is shown a flow diagram illustrating a method of cleaning a pipe interior according to the present invention. The method comprises providing 200 the vacuum head apparatus 10 as described herein. The method further comprises inserting 202 vacuum head apparatus 10 into a pipe wherein plurality of circumferential fins 22 engage an interior surface of the pipe. For embodiments employing the flexible second embodiment construction, the engagement may involve radial compression of tubular body 12 and fins 22 when the exterior diameter of vacuum head apparatus 10 in its relaxed state exceeds the interior diameter of target pipe 118. For embodiments employing the rigid first embodiment construction, the engagement involves positioning vacuum head apparatus 10 within target pipe 118 such that fins 22 contact pipe interior surface 120.

The method further comprises applying 204 vacuum pressure to proximal end 16 of vacuum head apparatus 10. In flexible embodiments, the application of vacuum pressure causes plurality of circumferential fins 22 to be drawn radially outward into enhanced sealing engagement with pipe interior surface 120, as the pressure differential between central passage 20 and the exterior environment tends to draw fins 22 against the pipe wall. In rigid embodiments, the application of vacuum pressure establishes suction forces at intake opening 26 for debris extraction while fins 22 maintain their fixed sealing

### Engagement With Pipe Interior Surface 120.

The method further comprises advancing 206 vacuum head apparatus 10 through target pipe 118 while maintaining engagement between plurality of circumferential fins 22 and pipe interior surface 120 and extracting debris through intake opening 26. Advancing 206 may be accomplished by pushing vacuum head apparatus 10 through target pipe 118 via flexible vacuum conduit 102, by pulling vacuum head apparatus 10 through target pipe 118 via tether 112, or by a combination of pushing and pulling techniques. As vacuum head apparatus 10 advances through target pipe 118, the angled orientation of intake plane 28 provides a scooping and scraping action that dislodges adhered debris and facilitates capture of loose materials. The sealing engagement between fins 22 and pipe interior surface 120 ensures that extracted debris is transported through central passage 20 and flexible vacuum conduit 102 to debris collection vessel 110 rather than escaping around the periphery of vacuum head apparatus 10.

In preferred embodiments, the method further comprises navigating 208 vacuum head apparatus 10 through a bend in target pipe 118. The domed exterior profile of distal end 18 facilitates smooth navigation through pipe bends by presenting a curved leading surface that glides along the outer radius of the bend. In flexible embodiments, plurality of circumferential fins 22 sequentially compress and expand to maintain sealing engagement throughout the bend, with fins 22 on the inside radius of the bend compressing more fully while fins 22 on the outside radius maintain extended sealing contact. In rigid embodiments, the dimensional relationship between fins 22 and the pipe interior diameter is selected to permit navigation through anticipated bend radii while maintaining sufficient sealing contact for effective debris extraction.

In preferred embodiments, the method further comprises withdrawing 210 vacuum head apparatus 10 through target pipe 118 in a direction opposite advancing 206, wherein plurality of circumferential fins 22 maintain engagement with pipe interior surface 120 during withdrawing 210. This bidirectional capability enables multiple passes through difficult sections and provides operational flexibility when encountering challenging debris accumulations. The orientation of fins 22 and the profile of intake opening 26 permit effective debris extraction during both forward advancement and rearward withdrawal, although forward advancement with intake opening 26 leading is generally preferred for optimal debris dislodgement and capture. The method concludes with complete extraction 212 of vacuum head apparatus 10 from target pipe 118 and collection of accumulated debris from debris collection vessel 110.

Vacuum head apparatus 10 is particularly well-suited for preparation of pipe interiors in advance of rehabilitation treatments. Modern trenchless pipe rehabilitation technologies, including cured-in-place pipe lining, spray-applied polymer coatings, and structural repair systems, depend critically upon proper surface preparation for successful application and long-term performance. Vacuum head apparatus 10 effectively removes debris, sediment, scale, and other contaminants from pipe interior surface 120 without introducing moisture that could interfere with the curing chemistry of rehabilitation materials. The thorough cleaning achieved by vacuum head apparatus 10 ensures proper mechanical bonding between rehabilitation materials and the host pipe substrate, reduces the incidence of coating failures and liner delamination, and improves the overall success rate of rehabilitation treatments.

The foregoing description merely explains and illustrates the invention and the invention is not limited thereto except insofar as the appended claims are so limited, as those skilled in the art who have the disclosure before them will be able to make modifications without departing from the scope of the invention.

While certain embodiments have been illustrated and described, it should be understood that changes and modifications can be made therein in accordance with ordinary skill in the art without departing from the technology in its broader aspects as defined in the following claims.

The embodiments illustratively described herein may suitably be practiced in the absence of any element or elements, limitation or limitations, not specifically disclosed herein. Thus, for example, the terms “comprising,” “including,” “containing,” and the like shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular systems and methods. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and the like. As a non-limiting example, each range discussed herein can be readily broken down into a lower third, middle third, and upper third, and the like. As will also be understood by one skilled in the art, all language such as “up to,” “at least,” “greater than,” “less than,” and the like include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A vacuum head apparatus for cleaning pipe interiors, comprising:
a tubular body defining a longitudinal axis and having a proximal end, a distal end, and a central passage extending therebetween for debris flow;
a plurality of circumferential fins extending radially outward from an exterior surface of said tubular body, said fins being arranged in spaced relation along said longitudinal axis; and
an intake opening formed at said distal end of said tubular body, said intake opening defining an intake plane oriented at a non-perpendicular angle relative to said longitudinal axis.

2. The vacuum head apparatus according to claim 1, wherein said plurality of circumferential fins are configured to sealingly engage an interior surface of a pipe when said vacuum head apparatus is disposed within said pipe.

3. The vacuum head apparatus according to claim 1, wherein said distal end of said tubular body comprises a domed exterior profile.

4. The vacuum head apparatus according to claim 1, further comprising a coupling structure disposed at said proximal end, said coupling structure configured for connection to a vacuum conduit.

5. The vacuum head apparatus according to claim 4, wherein said coupling structure comprises a threaded exterior surface.

6. The vacuum head apparatus according to claim 1, wherein said tubular body is flexible and radially compressible from a relaxed state to a compressed state.

7. The vacuum head apparatus according to claim 6, wherein each of said plurality of circumferential fins is independently compressible in a radial direction.

8. The vacuum head apparatus according to claim 7, wherein said tubular body comprises an elastomeric material having a first durometer hardness value, and wherein said plurality of circumferential fins comprise an elastomeric material having a second durometer hardness value less than said first durometer hardness value.

9. The vacuum head apparatus according to claim 8, wherein said first durometer hardness value is between approximately 60 and 80 Shore A, and wherein said second durometer hardness value is between approximately 30 and 50 Shore A.

10. The vacuum head apparatus according to claim 6, wherein said plurality of circumferential fins comprises a first fin positioned adjacent said proximal end and a last fin positioned adjacent said distal end, and wherein fins positioned nearer said proximal end exhibit greater stiffness than fins positioned nearer said distal end.

11. The vacuum head apparatus according to claim 1, further comprising at least one internal reinforcement structure disposed within said central passage, said internal reinforcement structure configured to resist radial collapse of said tubular body under applied vacuum pressure.

12. The vacuum head apparatus according to claim 1, wherein said plurality of circumferential fins comprises at least four fins, and wherein adjacent fins are separated by a substantially uniform spacing distance.

13. A method of cleaning a pipe interior, comprising the steps of:
providing the vacuum head apparatus according to claim 1;
inserting said vacuum head apparatus into a pipe wherein said plurality of circumferential fins engage an interior surface of said pipe;
applying vacuum pressure to said proximal end of said vacuum head apparatus; and
advancing said vacuum head apparatus through said pipe while maintaining engagement between said plurality of circumferential fins and said interior surface and extracting debris through said intake opening.

14. The method according to claim 13, further comprising the step of withdrawing said vacuum head apparatus through said pipe in a direction opposite said advancing, wherein said plurality of circumferential fins maintain engagement with said interior surface during said withdrawing.

15. The method according to claim 13, further comprising the step of navigating said vacuum head apparatus through a bend in said pipe.

16. The method according to claim 13, wherein said advancing comprises pulling said vacuum head apparatus through said pipe via a tether connected to said distal end.

17. A system for cleaning pipe interiors, comprising:
the vacuum head apparatus according to claim 1;
a flexible vacuum conduit having a first end connected to said proximal end of said vacuum head apparatus and a second end; and
a vacuum source connected to said second end of said flexible vacuum conduit.

18. The system according to claim 17, further comprising a debris collection vessel disposed in fluid communication between said flexible vacuum conduit and said vacuum source.

19. The system according to claim 17, further comprising a tether having a first tether end connected to said vacuum head apparatus at or adjacent said distal end and a second tether end extending externally of a pipe for manipulation by an operator.

20. The system according to claim 17, wherein said flexible vacuum conduit has an interior diameter substantially equal to an interior diameter of said central passage of said vacuum head apparatus.
